(19) United States
(12) Patent Application Publication
(10) Pub. No.: US 2021/0031480 A1
(43) Pub. Date: Feb. 4, 2021

(54) REUSABLE BAG APPARATUS AND METHODS OF MANUFACTURE THEREOF

(71) Applicant: NEW YORK PACKAGING II, New York, NY (US)

(72) Inventor: Jeffrey RABIEA, New Hyde Park, NY (US)

(21) Appl. No.: 16/531,087

(22) Filed: Aug. 4, 2019

(51) Int. Cl. B31B 70/86; B65D 33/10

(52) U.S. Cl. CPC B31B 70/864; B65D 2203/02; B65D 33/105

(57) ABSTRACT

A reuseable bag with handles is formed of a single sheet, folded to form two sides and a bottom, and includes only heat-seals formed using heat and pressure along side edges and width-wise across an upper portion of each side wall forming reinforced regions of the bag walls at which handle attachment points are disposed for attaching handles by heat-sealing using heat and pressure.

### FIELD

The disclosure relates to pouches or bags. In particular, the disclosure relates to flexible, reusable pouches or bags having handles.

### BACKGROUND

Conventional, single use plastic bags used around the world for shopping have an enormous impact on the environment because they contribute to vast amounts of waste. Yet, single use plastic bags are desired because they are inexpensive, light, and flexible enough to easily conform to goods and fold compactly for packaging, and yet strong enough to support a full load of goods.

Conventional bags, including some reuseable bags, may include one or more handles. For example, some bags are made of a non-woven fabric sheet or sheets arranged to form a bag and defining an opening. To ensure adequate strength for both single and repeated uses, sewing is used to seal side and bottom edges, in addition to handle attachment points for convention reuseable bags. For example, the top peripheral edge of the conventional bag may include a double-layer portion that is formed by folding down the top portion of the bag at the opening. The double-layer portion is both sewn and bonded by discontinuous ultrasonic sealing. A strip having two ends is attached to the bag to form a handle. Each end of the strip may be arranged to contact the double-layered portion of the bag by an interposing attachment member to provide additional strength. The handle and attachment portion are fastened to the double-layer of the bag by a combination of sewing, heat sealing, and ultrasonic sealing.

Some related art bags include only partial sewing in addition to the heat sealing and ultrasonic sealing. The partial sewing rather than complete sewing minimizes manufacturing costs and time while imparting a bond having a strength sufficient for multiple bag uses.

### SUMMARY

A need has been recognized for bags with handles and having a strength sufficient for multiple while having a thin profile, flexibility, and a manufacturing cost corresponding with costs of, and thus competitive to, conventional single use bags. A bag having flexible profile, a handle, and a strength and durability suitable for multiple, repeated bag uses while having a manufacturing cost and material cost competitive with conventional bags is disclosed. An increasing and unmet demand exists for packaging configured for multiple uses to minimize material waste and environmental impact. Bag apparatus and methods of manufacture thereof in accordance with embodiments disclosed herein meet these needs and demands.

Bag apparatus and methods of manufacture thereof in accordance with embodiments of the disclosure enable efficient use of packaging materials, minimizing packing costs, maximizing utility, and minimizing environmental impact of disposable bag and pouch usage. Reusable bags in accordance with embodiments of the disclosure are configured for compact folding, and include a strong, resilient handle pair. Bags of embodiments may be formed of woven or non-woven material that is suitable for heat and pressure sealing.

In an embodiment, the bag or pouch is formed of suitable material, which may be woven or non-woven. In embodiments, the material comprises polyethylene. For example, the polyethylene may comprise recycled polyethylene. In embodiments, the material may comprise polypropylene.

In an embodiment, the bag or pouch is formed of any material now known or later developed and useful for forming sealable bags or pouches. The bags or pouches may be cut and constructed to be any suitable size or shape. By way of example, bag apparatus of an embodiment may be formed to have a width of 18 inches, a length of 17 inches, and a bottom of 6 inches across. In an embodiment, a thickness of the bag lies in a range of thicknesses, measured in units of gram weights, of 30 grams per square meter to 150 grams per square meter, for example. The bag apparatus has handles and is foldable for efficient storage and flexible for conformability to contents.

An embodiment of a bag apparatus includes a first bag wall; a second bag wall aligned and joined to the first bag wall at a first sealed side edge, a second sealed side edge, a sealed bottom including a heat sealed edge and a substantially planar bottom surface that is foldable, and an unsealed top edge; a first handle having a first end and a second end; and a second handle having a first end and a second end, each of the first and the second handles are heat and pressure sealed directly onto a double-layered portion of the first and second bag walls, respectively, with no interposing member or material. The sides edges, bottom edges, and handle attachment points consist of heat and pressure seals and exclude stitching.

In an embodiment, the first wall and the second wall comprise polyethylene, for example recycled polyethylene. In an embodiment, the bag or pouch is formed of suitable material, which may be woven or non-woven. In an embodiment, the material comprises polypropylene.

In an embodiment of methods, a method of forming a bag includes providing a planar, flexible sheet comprising a material suitable for heat sealing; folding the sheet to form a first side portion or first wall, a bottom portion, and a second side portion or second wall; folding top portions of each of the first side portion and the second side portion down onto themselves, and only heat and pressure sealing to form a double-layered portion at each of the top portions of the first side portion and second side portion; joining the first side portion to the second side portion and using only heat and pressure sealing to form two sealed side edges leaving an open top edge, wherein the heat sealing on the double-layered portions intersects the heat sealing on the two side edges; and attaching handles to attachment points disposed at the double-layered portions of the top edge of the bag, the handles attached only by heat and pressure sealing.

Additional features and technical effects of the present disclosure will become readily apparent to those skilled in the art from the following detailed description wherein embodiments of the present disclosure are described simply by way of illustration of the best mode contemplated to carry out the present disclosure. In addition to the embodiments disclosed herein, other and different embodiments are within the spirit and scope of the disclosure, and its several details are capable of modifications in various respects.

### BRIEF DESCRIPTION OF DRAWINGS

The disclosure is shown by way of example in the figures of the accompanying drawings, in which like reference numerals refer to like elements.

FIG. 1 shows a perspective view of a bag with handles in accordance with an embodiment;

FIG. 2A shows a top view of a bag with handles in accordance with an embodiment;

FIG. 2B shows a bottom view of a bag with handles in accordance with an embodiment;

FIG. 3A shows a front view of a bag with handles in accordance with an embodiment;

FIG. 3B shows a back view of a bag with handles in accordance with an embodiment;

FIG. 4A shows a side view of a bag with handles in accordance with an embodiment;

FIG. 4B shows a side view of a bag with handles in accordance with an embodiment;

FIG. 5 shows a perspective view of a bag with handles in accordance with another embodiment;

FIG. 6A shows a top view of a bag with handles in accordance with an embodiment;

FIG. 6B shows a bottom view of a bag in accordance with an embodiment;

FIG. 7A shows a front view of a bag with handles in accordance with an embodiment;

FIG. 7B shows a back view of a bag with handles in accordance with an embodiment;

FIG. 8A shows a side view of a bag with handles in accordance with an embodiment;

FIG. 8B shows a side view of a bag with handles in accordance with an embodiment;

FIG. 9 shows a method useful for manufacturing a bag with handles in accordance with an embodiment.

### DETAILED DESCRIPTION OF EMBODIMENTS

In the following description, for the purposes of explanation, numerous specific details are set forth in order to provide a thorough understanding of exemplary embodiments. It should be apparent, however, that exemplary embodiments may be practiced without these specific details or with an equivalent arrangement. In other instances, well-known structures and devices are shown in block diagram form in order to avoid unnecessarily obscuring exemplary embodiments. In addition, unless otherwise indicated, all numbers expressing quantities, ratios, and numerical properties of ingredients, reaction conditions, and so forth used in the specification and claims are to be understood as being modified in all instances by the term “about.”

Embodiments of bag apparatus and methods of manufacture thereof are disclosed. Apparatus of embodiments advantageously include handles configured and attached to a reusable bag configured for flexibility and conformability, and formed of any now known or later developed material, including woven or non-woven polymeric material, such as, for example polypropylene, or polyethylene. For the example, the bag wall material may comprise recycled polyethylene. Consumer demand for plastic bags has previously been met by providing thin plastic bags that are flexible, light, and inexpensive, but at the expense of durability and typically configured limited or single use. Recently, consumer demand has increasingly required flexible, thin, and light bags having sufficient strength for multiple uses. Reusable bags with handles and having flexibility, and minimal materials and manufacturing costs are disclosed.

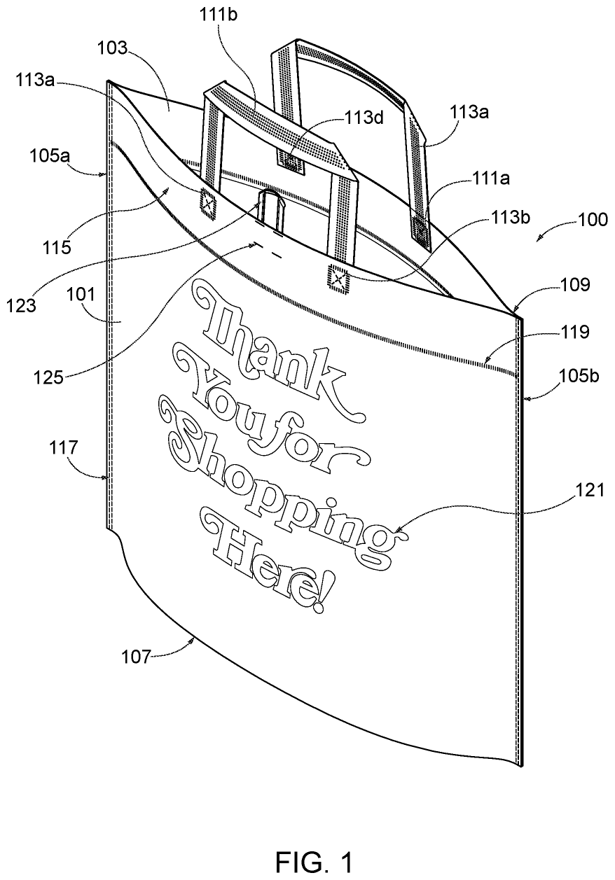

A reusable bag with handles is shown in FIG. 1. In particular, FIG. 1 shows a perspective view of a bag 100 including a first wall 101 aligned and joined to a second sheet 103 at two sealed side edges 105a-b, and a bottom 107, leaving an open unsealed fourth side edge 109. The walls may be formed of any now known or later developed material such as polypropylene and polyethylene. The sheet material may be clear, colored, or printable, woven or unwoven.

A thickness of the sheets or bag walls may be any useful thickness, and preferably have a thin profile. In some embodiments, the bag walls each have a thickness lying in a range of 0.0002 inches through 0.0040 inches. In some embodiments, a thickness of the bag lies in a range of thicknesses, measured in units of gram weights, of 30 grams per square meter to 150 grams per square meter.

The side edges 105a and 105b of the walls are heat-sealed using heat and pressure. No stitching is used. The edges of the bottom 107 are also heat-sealed. A pair of handles 111a-b separate from the two sheets and attached thereto at handle attachment points 113a-d by heat-sealing using heat and pressure are configured for carrying the bag. The bag wall top edges at the fourth side of the bag are each double-layered. The double-layer portion 115 is formed by folding a portion of each sheet or wall 101 and 103 onto itself during manufacture, and heat-sealing the folded portion from the first side edge 105a to the second side edge 105b. Each of the handles 111a-b may be single-layered, or double-layered, and are attached directly to the bag 100 by the attachment points 113a-d, which are located on the double-layered portion 115. There are no materials or members interposing the handles 111a-b and surfaces at the attachments points 113a-d. It has been found that the combination of heat-sealing only of side and bottom edges and across a width of each of the first wall 101 and the second wall 103, use of the double-layered portion 115 for anchoring attachment points 113a-d, and using only heat-sealing at the attachment points, contribute to durability while accommodating use of flexible, conformable material. The material may also be printable, as shown in the drawings by example, referring to printed label 121.

The handles are attached to the double-layered portion of the bag at attachment points by heat-sealing using a combination of heat and pressure by well known methods and apparatus. In some embodiments, for example, the height of the double-layered portion is ⅕ of the distance between the attachment points.

Such a handle configuration is shown in FIG. 1. In particular, FIG. 1 shows handles 111a and 111b, each having two ends attached to two attachment points 113a-d located on a double-layered portion 115 at the fourth side 107 of the bag 100. Specifically, a first pair of attachment points 113 are disposed on the first sheet 101, and a second pair of attachment points 113c-d are disposed on the second sheet 103 opposite the first pair of attachment points 113a-b. The height of the double-layered portion 115 may be 30 mm. The distance between the attachments points 113a-b, like the distance between the attachment points 113c-d, may be 150 mm. Thus, the height of the double-layered portion 115 would be ⅕ the distance between attachment points as shown in FIG. 1. This configuration imparts sufficient bag strength for re-use while requiring minimal materials and manufacturing costs by enabling use of heat-sealing processes without costly and time consuming stitching or other sealing methods.

The sides edges 105a-b comprise heat-seals 117, and the double-layered portion 115 comprises a width-wise heat-seal 119 running across a width of the bag 100 from the first side edge 105a to the second side edge 105b.

FIG. 1 shows printing 121 on the surface of the first wall 101. FIG. 1 shows a loop 123 attached to the first side 101 of the bag 100. The loop 123 is attached by stitching 125.

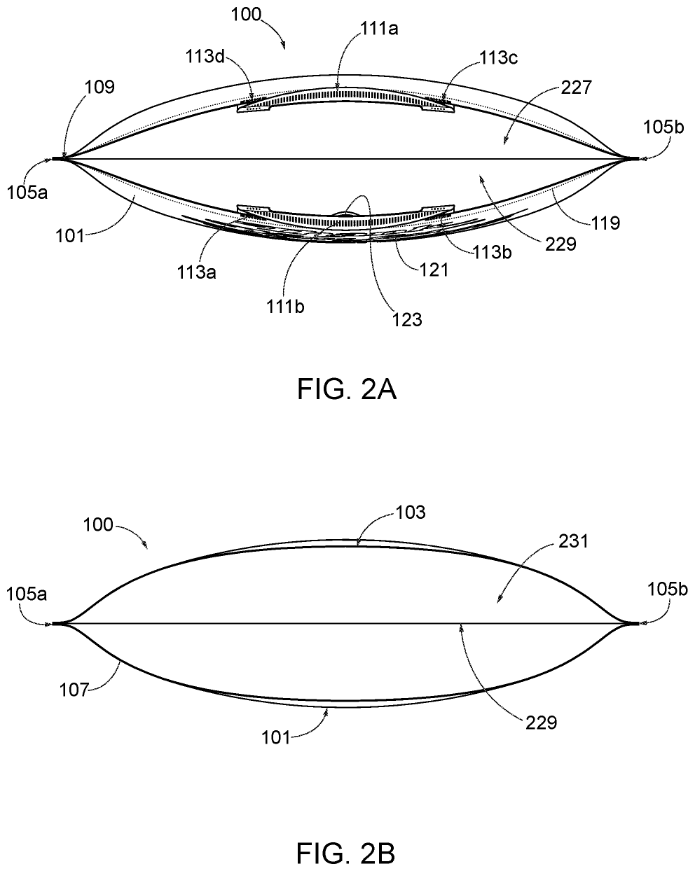

FIG. 2A shows a top view of a bag having handles in accordance with an embodiment. In particular, FIG. 2A shows a top view of a bag 100, including a first sheet or wall 101 aligned and joined to a second sheet or wall 103 at two sides 105a-b and a bottom (not shown), leaving an open unsealed fourth side 109. Handles 111a and 111b are attached to the bag at attachment points 113a-d disposed on a double-layered portion 115 of the sheet 101 and the sheet 102 of the bag 100. For example, in the embodiment shown in FIG. 2A, the height of the double-layered portion 112 is ⅕ the distance between the attachment points 111a-b on the first sheet 101, and the distance between the attachment points 111c-d on the second sheet 103.

FIG. 2A shows a hanging loop 123 configured for hanging the bag. The hanging loop may be formed of the same materials as the bag and handle, and may be heat-sealed, stitched, or a combination thereof, to the bag.

FIG. 2A shows a bag interior bottom surface 227. The interior bottom surface 227 is foldable along a fold line 229. Thus, the bag 100 is collapsible for storage, and expandable for use. Additionally, the bottom surface fold configuration avoids a heat-seal seam located directly at the bottom of the bag, thus enhancing strength and durability.

FIG. 2B shows a bottom view of the bag having handles in accordance with an embodiment shown in FIG. 2A. In particular, FIG. 2B shows a bag 100, including the first sheet 101 aligned and joined to the second sheet 103 at two sides 105a-b, and a bottom 107. FIG. 2B shows the fold line 229 along an exterior bottom surface 231 of the bag 100.

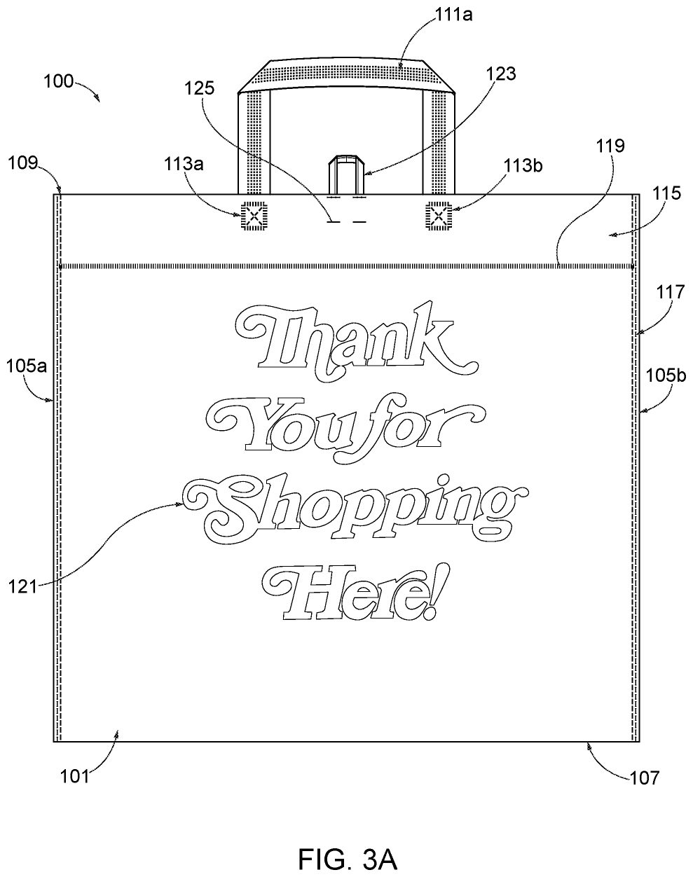

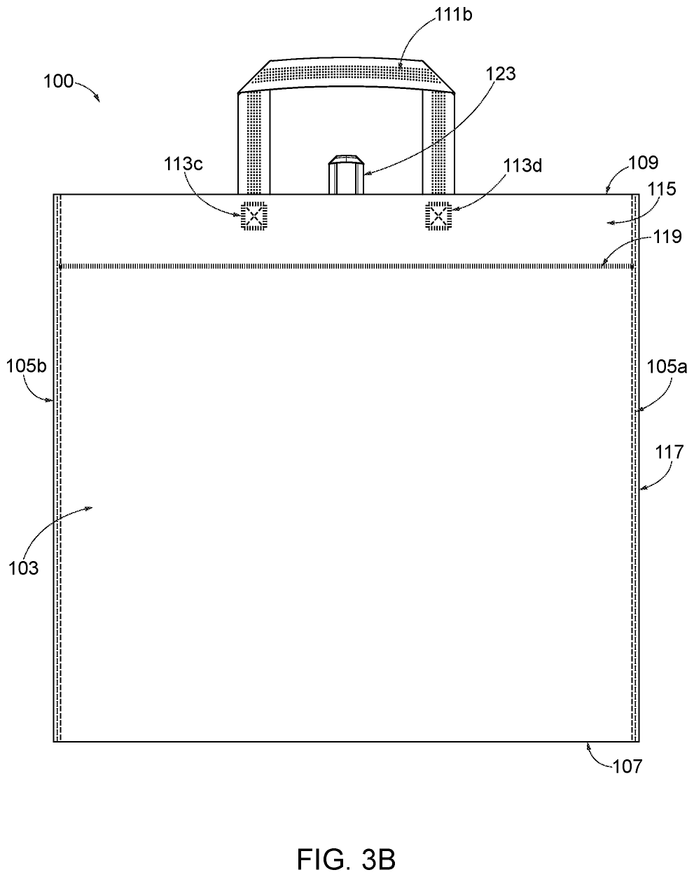

FIG. 3A shows a front view of a bag with handles in accordance with an embodiment. In particular, FIG. 3A shows a bag 100 including a first sheet 101 aligned and joined to a second sheet (not shown) at two sides 105a-b, and a bottom 107, leaving an open unsealed fourth side 109. FIG. 3A shows handles 111a and 111b, each having two ends attached to two attachment points 113a-b located on a double-layered portion 115 at the fourth side 109 of the bag 100. Specifically, a first pair of attachment points 113a-b are disposed on the first sheet 101, and a second pair of attachment points (not shown) are disposed on the second sheet 103 opposite the first pair of attachment points 113a-b. The height of the double-layered portion 115 is shown by way of example in FIG. 1 as 30 mm. The distance between the attachments points 113a-b, like the distance between the attachment points on the second sheet, is 150 mm. Thus, the height of the double-layered portion 115 is ⅕ the distance between attachment points.

The side edges 105a-b comprise heat-seals 117, and the double-layered portion 115 comprises a width-wise heat-seal 119 running across a width of the bag 100 from the first side edge 105a to the second side edge 105b.

FIG. 3A shows printing 121 on the surface of the first wall 101. FIG. 3A shows a loop 123 attached to the first side 101 of the bag 100. The loop 123 is attached by stitching 125.

FIG. 3B shows a rear view of the bag 100 shown in FIG. 3A. FIG. 3B shows attachment points 113c-d. The handle 111b shown in FIG. 3B is attached to the attachment points 113c-d by heat and pressure sealing only.

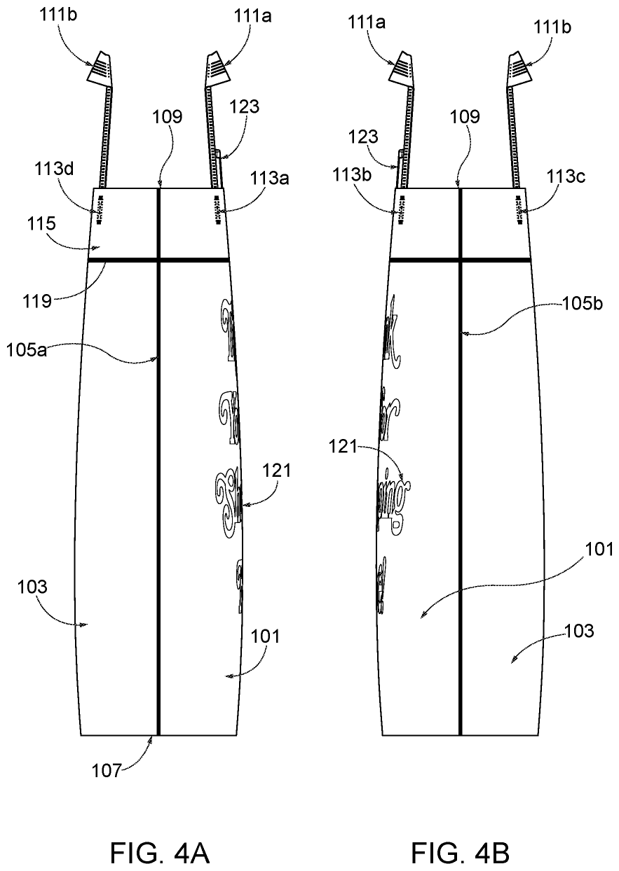

FIGS. 4A-4B shows side views of the bag 100 shown in FIGS. 1-3B. FIGS. 4A-4B show that the bottom 107 of the bag 100 is a foldable surface that is expandable to form a substantially planar surface. This configuration contributes, for example, to bag strength and durability by avoiding a bottom seal.

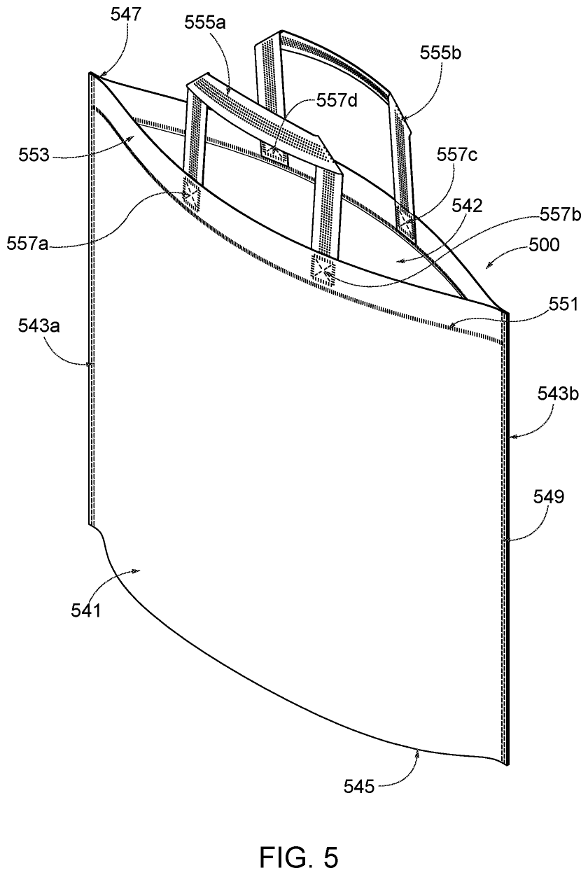

A reusable bag with handles is shown in FIG. 5. In particular, FIG. 5 shows a perspective view of a bag 500 including a first wall 541 aligned and joined to a second wall 542 at two sealed side edges 543a-b, and a bottom 545, leaving an open unsealed fourth side edge 547. The walls or sheets may be formed of any now known or later developed material such as polypropylene and polyethylene. The sheet material may be clear, colored, or printable, woven or unwoven.

A thickness of the sheets or bag walls may be any useful thickness, and preferably have a thin profile. In some embodiments, the bag walls are formed of polypropylene and polyethylene, each have a thickness lying in a range of 0.0002 inches through 0.0040 inches. In some embodiments, a thickness of the bag lies in a range of thicknesses, measured in units of gram weights, of 30 grams per square meter to 150 grams per square meter, for example.

The side edges 543a and 543b of the walls are heat-sealed using heat and pressure forming side edge heat seals 549. No stitching is used. The edges of the bottom 545 are also heat-sealed. A pair of handles 555a-b, separate from the two sheets or walls and attached thereto at handle attachment points 557a-d by heat-sealing using heat and pressure, are configured for carrying the bag. The bag wall top edges at the fourth side or top of the bag are each double-layered. The double-layer portion 553 is formed by folding a portion of each sheet or wall 541 and 542 onto itself during manufacture, and heat-sealing the folded portion from the first side edge 543a to the second side edge 543b to form a heat seal 551. Each of the handles 555a-b may be single-layered, or double-layered, and are attached to the bag 500 by the attachment points 557a-d, which are located on the double-layered portion 553. It has been found that the combination of heat-sealing only of side edges and across a width of each of the first wall 541 and the second wall 541, use of the double-layered portion 553 for anchoring attachment points 557a-d, and heat-sealing only at the attachment points, contribute to enhanced durability while accommodating use of flexible, conformable material.

The handles are attached to the double-layered portion of the bag at attachment points by heat-sealing using a combination of heat and pressure by well known methods and apparatus. In some embodiments, the height of the double-layered portion is far less than the distance between the attachment points.

Such a handle configuration is shown in FIG. 5. In particular, FIG. 5 shows handles 555a and 555b, each having two ends attached to two attachment points 557a-d located on a double-layered portion 553 at the fourth side 547 of the bag 500. Specifically, a first pair of attachment points 557a-b are disposed on the first sheet 541, and a second pair of attachment points 557c-d are disposed on the second sheet 542 opposite the first pair of attachment points 557a-b. The height of the double-layered portion 553 is shown by way of example in FIG. 5 slightly more than the height of a single attachment point seal.

The sides edges 543a-b comprise heat-seals 549, and the double-layered portion 553 comprises a width-wise heat-seal 551 running across a width of the bag 500 from the first side edge 543a to the second side edge 543b. This configuration has been found to impart strength and durability to the bag 500.

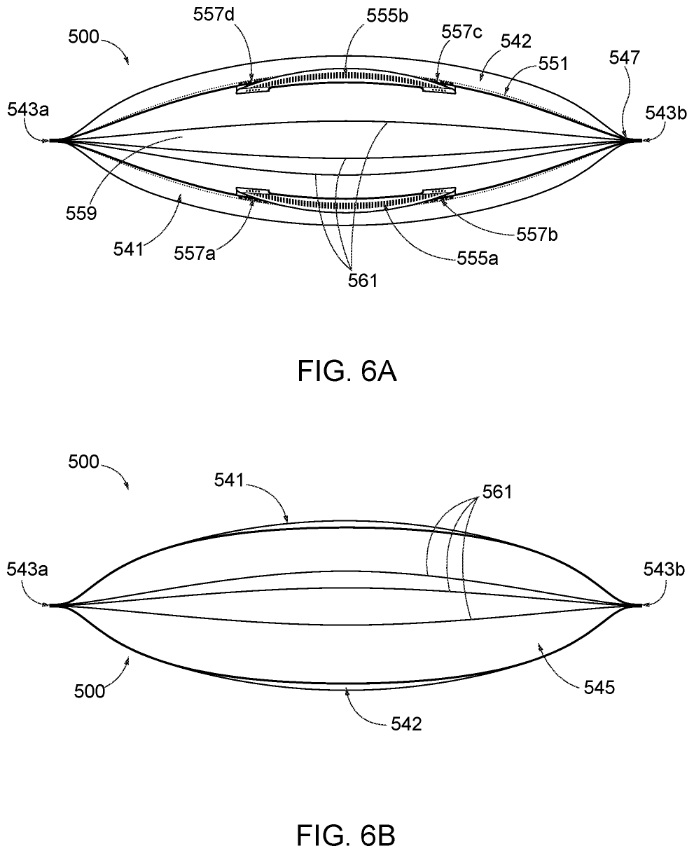

FIG. 6A shows a top view of a bag having handles in accordance with an embodiment. In particular, FIG. 6A shows a top view of a bag 500, including a first sheet or wall 541 aligned and joined to a second sheet or wall 542 at two sides 543a-b and a bottom (not shown), leaving an open unsealed fourth side 547. Handles 555a and 555b are attached to the bag at attachment points 557a-d disposed on a double-layered portion 553 of the sheet 541 and the sheet 542 of the bag 500. For example, in the embodiment shown in FIG. 6A, the height of the double-layered portion 112 is ⅕ the distance between the attachment points 111a-b on the first sheet 101, and the distance between the attachment points 111c-d on the second sheet 103.

FIG. 6A shows a bag interior bottom surface 559. The interior bottom surface 559 is foldable along multiple fold lines 561. Thus, the bag 500 is collapsible for storage, and expandable for use. Additionally, the bottom surface fold configuration avoids a heat-seal seam located directly at the bottom of the bag, thus enhancing strength and durability.

FIG. 6B shows a bottom view of the bag having handles in accordance with an embodiment shown in FIG. 6A. In particular, FIG. 6B shows a bag 500, including the first sheet 541 aligned and joined to the second sheet 542 at two sides 543a-b, and a bottom 545. FIG. 6B shows the multiple fold lines 561 along an exterior bottom surface of the bag 500.

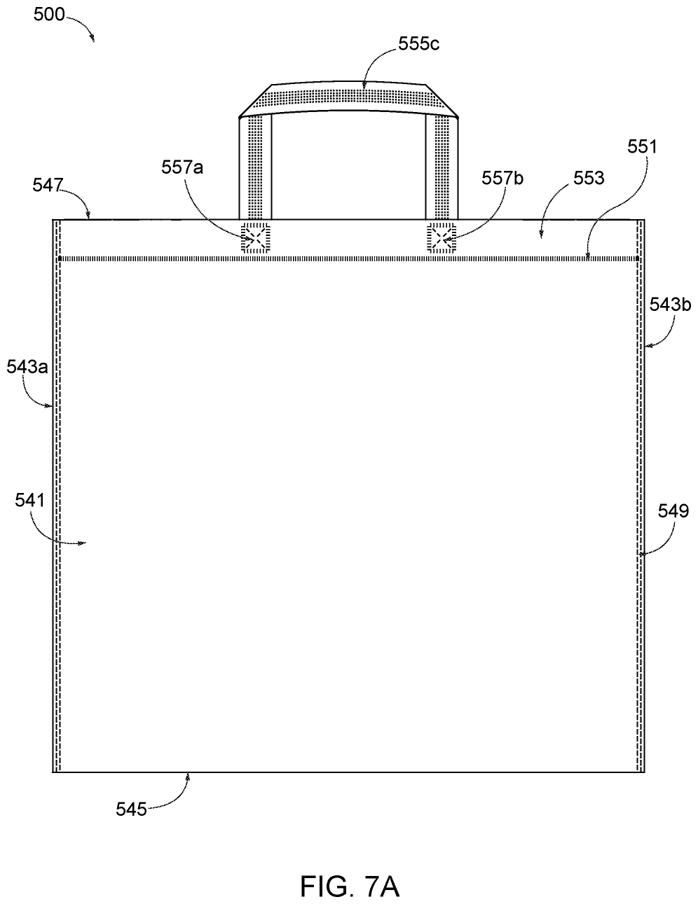

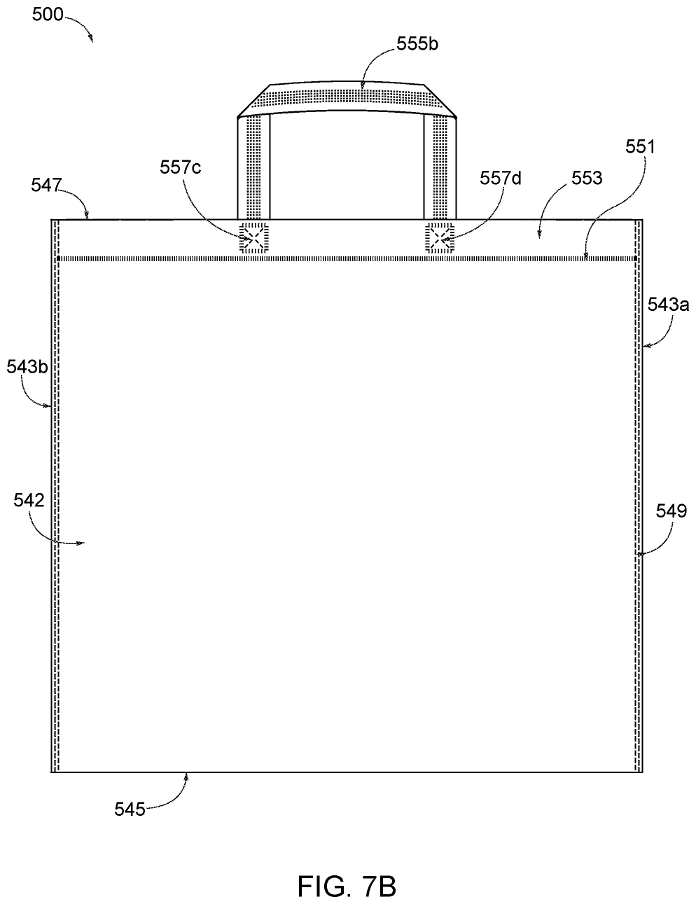

FIG. 7A shows a front view of a bag with handles in accordance with an embodiment. In particular, FIG. 7A shows a bag 500 including a first sheet 541 aligned and joined to a second sheet (not shown) at two sides 543a-b, and a bottom 545, leaving an open unsealed fourth side 547. FIG. 7A shows handles 555a and 555b, each having two ends attached to two attachment points 557a-b located on a double-layered portion 553 at the fourth side 547 of the bag 500. Specifically, a first pair of attachment points 557a-b are disposed on the first sheet 541, and a second pair of attachment points (not shown) are disposed on the second sheet (not shown) opposite the first pair of attachment points 557a-b.

The side edges 543a-b comprise heat-seals 549, and the double-layered portion 553 comprises a width-wise heat-seal 551 running across a width of the bag 500 from the first side edge 543a to the second side edge 543b.

FIG. 7B shows a rear view of the bag 500 shown in FIG. 7A. FIG. 7B shows attachment points 557c-d. The handle 555b shown in FIG. 3B is attached to the attachment points 557c-d by heat and pressure sealing only.

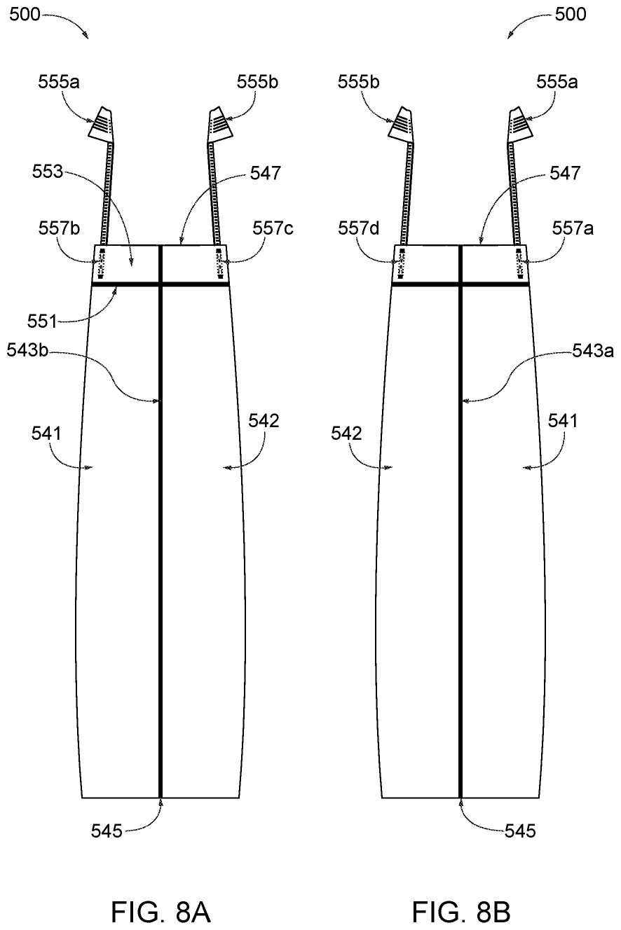

FIGS. 8A-8B shows side views of the bag 500 shown in FIGS. 5-7B. FIGS. 8A-8B show that bottom 545 of the bag 500 is a planar surface that is expandable to form a substantially planar surface. This configuration contributes to bag strength and durability by avoiding a bottom seal.

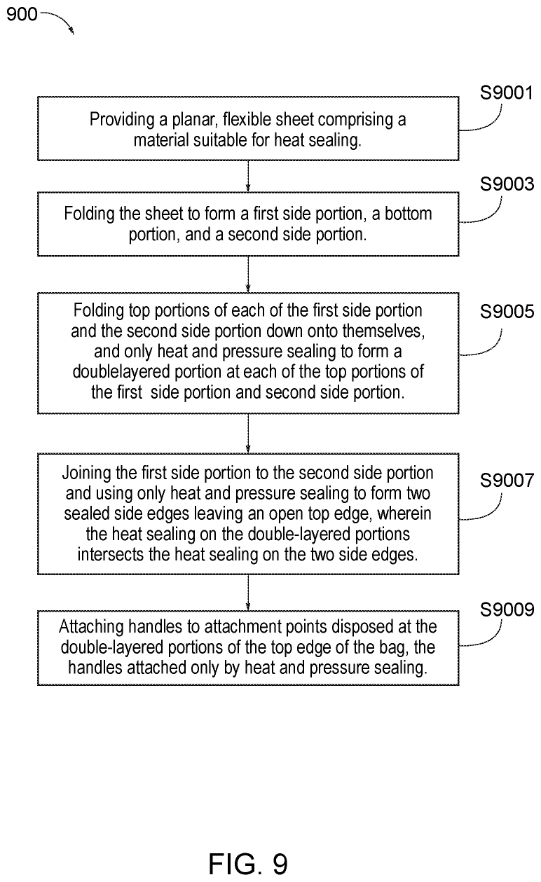

FIG. 9 shows an embodiment of methods useful for manufacturing a bag with handles as shown in FIGS. 1-8B. In particular, FIG. 9 shows a process 900 including providing a planar, flexible sheet comprising a material suitable for heat sealing at S9001; folding the sheet to form a first side portion or first wall, a bottom portion, and a second side portion or second wall at S9003; folding top portions of each of the first side portion and the second side portion down onto themselves, and only heat and pressure sealing to form a double-layered portion at each of the top portions of the first side portion and second side portion at S9005; joining the first side portion to the second side portion and using only heat and pressure sealing to form two sealed side edges leaving an open top edge, wherein the heat sealing on the double-layered portions intersects the heat sealing on the two side edges at S9007; and attaching handles to attachment points disposed at the double-layered portions of the top edge of the bag, the handles attached only by heat and pressure sealing at S9009.

Embodiments are shown by way of example, and not by way of limitation in the figures and drawings. While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A bag apparatus, comprising:
a first bag wall;
a second bag wall aligned and joined to the first bag wall at a first sealed side edge, a second sealed side edge;
a bag bottom comprising a substantially planar, foldable surface, wherein the first sealed side edge and the second sealed side edge consist of heat-seals running along an entire height of the first bag wall and the second bag wall;
a first double-layered portion formed in the first bag wall at the top edge and comprising a first width-wise heat seal;
a second double-layered portion formed in the second bag wall at the top edge and comprising a second width-wise heat seal;
a first handle attachment point and a second handle attachment point disposed on the first double-layered portion, wherein a distance between the first attachment point and the second attachment point is five times a height of the first double-layered portion;
a third handle attachment point and a fourth handle attachment point disposed on the second double-layered portion, wherein a distance between the third attachment point and the fourth attachment point is five times a height of the second double-layered portion;
a first handle attached to the first attachment point and the second attachment point by heat-seal only; and
a second handle attached to the third attachment point and the fourth attachment point by heat-seal only.

2. The apparatus of claim 1, comprising:
a first wall comprising printing.

3. The apparatus of claim 1, comprising:
a hanging loop attached to the first double-layered portion of the first wall.

4. A bag apparatus, comprising:
a first bag wall;
a second bag wall aligned and joined to the first bag wall at a first sealed side edge, a second sealed side edge;
a bag bottom comprising a substantially planar, foldable surface, wherein the first sealed side edge and the second sealed side edge consist of heat-seals running along an entire height of the first bag wall and the second bag wall;
a first double-layered portion formed in the first bag wall at the top edge and comprising a first width-wise heat seal; and
a second double-layered portion formed in the second bag wall at the top edge and comprising a second width-wise heat seal.

5. The apparatus of claim 4, comprising:
a first handle attachment point and a second handle attachment point disposed on the first double-layered portion, wherein a distance between the first attachment point and the
second attachment point is five times a height of the first double-layered portion; and
a third handle attachment point and a fourth handle attachment point disposed on the second double-layered portion, wherein a distance between the third attachment point and the fourth attachment point is five times a height of the second double-layered portion.

6. The apparatus of claim 5, comprising:
a first handle attached to the first attachment point and the second attachment point by heat-seal only; and
a second handle attached to the third attachment point and the fourth attachment point by heat-seal only.

7. The apparatus of claim 5, comprising:
a hanging loop stitched to the first wall at the first double-layered portion thereof.

8. The apparatus of claim 5, printing on the first wall.

9. The apparatus of claim 5, the bottom, the first wall, and the second wall comprising a flexible material.

10. A method of forming a bag, comprising:
providing a planar, flexible sheet comprising a material suitable for heat sealing;
folding the sheet to form a first side portion, a bottom portion, and a second side portion;
folding top portions of each of the first side portion and the second side portion down onto themselves, and only heat and pressure sealing to form a double layered portion at each of the top portions of the first side portion and second side portion;
joining the first side portion to the second side portion and using only heat and pressure sealing to form two sealed side edges leaving an open top edge, wherein the heat sealing on the double-layered portions intersects the heat sealing on the two side edges; and
attaching handles to attachment points disposed at the double-layered portions of the top edge of the bag, the handles attached only by heat and pressure sealing.

11. The apparatus of claim 1, the material further comprising polypropylene.

12. The apparatus of claim 1, the material further comprising polyethylene.

13. The method of claim 10, the material further comprising polypropylene.

14. The apparatus of claim 10, the material further comprising polyethylene.

15. The apparatus of claim 1, the bag comprising a thickness in a range of thicknesses, measured in units of gram weights, of 30 grams per square meter to 150 grams per square meter.

16. The method of claim 10, the bag comprising a thickness in a range of thicknesses, measured in units of gram weights, of 30 grams per square meter to 150 grams per square meter.
